(19) United States
(12) Patent Application Publication
(10) Pub. No.: US 2009/0112346 A1
(43) Pub. Date: Apr. 30, 2009

(54) Method and System for Adaptive Equipment Notifications

(76) Inventor: Steffen Tichatschke, Soquel, CA (US)

Correspondence Address: Steffen Tichatschke, P.O. Box 1866, Capitola, CA, 95010-1866, US

(21) Appl. No.: 12/245,405

(22) Filed: Oct. 3, 2008

Related U.S. Application Data
(60) Provisional application No. 60/982,406, filed on Oct. 24, 2007.

(51) Int. Cl. G06F 19/00; G06F 15/16

(52) U.S. Cl. 700/108; 709/204

(57) ABSTRACT

The present invention improves on existing Equipment Fault Detection and Classification (FDC) and Equipment Automation methods and systems. Its novelty is in a new method and system to provide adaptive notifications based on the basic capability to detect interruptions and out-of-process-spec conditions at automated manufacturing or processing equipment through the existing methods of prior art. The reality of adaptive notifications is very important in order to manage the complexity of automated production environments, such as in the semiconductor and chemical industries, power generation utilities, durable goods manufacturing and food processing industry. The method and system described in the present invention result in actionable equipment notifications, which is a key differentiator. Existing methods of prior art frequently generate large quantities of data requiring further analysis before an action can be determined, and thereby consuming valuable production time.

### CROSS-REFERENCE TO RELATED APPLICATIONS

This application is the corresponding non-provisional application for provisional application No. 60/982,406 filed on Oct. 24, 2007.

### BACKGROUND OF THE INVENTION

Semiconductor manufacturing consists of a number of complex process steps which are performed on various types of equipment. In most modern manufacturing environments, especially those with a wafer size of 300 mm, most of the utilized production equipment is equipped with a computer network interface, known as an Equipment Automation Interface to those skilled in the art. Such Equipment Automation Interface allows for a central factory controller, known as the Factory Control Host to those skilled in the art, to send commands to the manufacturing equipment. The same interface is utilized by the equipment to send data about its internal state to the Factory Control Host. SEMI Standards exist for recommended implementation of an Equipment Automation Interface.

The set of production equipment installed in a single manufacturing facility often exceeds 100 pieces of processing equipment. Managing the productivity of this equipment set in the factory is a high priority for semiconductor manufacturers.

The equipment productivity is largely affected by the following three categories:
1. Planned interruptions to the normal processing.
2. Unplanned interruptions to the normal processing.
3. Production outside of the process specification that the equipment is capable of, resulting in scrap material.

Planned interruptions include timeframes for required equipment maintenance. Unplanned interruptions are usually caused by a fault within the production equipment that needs to be attended to by an engineer in order to diagnose and correct. Out of process specification production may occur either due to erroneous equipment settings or due to time drift of equipment capabilities.

A manufacturer will often produce several products in parallel, which results in varying sets of processing instructions to the equipment.

While the present invention is described in the context of the semiconductor manufacturing industry, the same method and system can be applied to other industries, where automated processing equipment is part of the production process, for instance the chemical industry, power generation utilities, durable goods manufacturing, and food processing industry.

### SUMMARY OF THE INVENTION

The present invention improves on existing Equipment Fault Detection and Classification (FDC) and Equipment Automation methods and systems known to those skilled in the art. It does not claim a new method for detecting planned or unplanned interruptions or out-of-process-spec conditions at the manufacturing equipment. Its novelty is in a new method and system to provide adaptive notifications based on the basic capability to detect the above described interruptions and out-of-process-spec conditions through existing methods. The concept of adaptive notifications is very important in order to manage the complexity of an automated manufacturing environment. The method and system described in the present invention result in actionable equipment notifications, which is a key differentiator. Existing methods of prior art frequently result in large quantities of data requiring further analysis before an action can be determined, and thereby consuming valuable production time. The system of the present invention will generate Adaptive Equipment Notifications primarily in the following two areas:
1. Automatic Notifications about equipment conditions that prevent wafer processing or may result in decreased production yield.
2. On-demand or Automatic Notifications that provide recommendations in order to schedule preventive maintenance operations for the equipment.

### DESCRIPTION OF DRAWINGS

FIG. 1 shows a functional schematic of an Equipment Process Window Module, also referred to with the acronym EPWM

FIG. 2 shows a possible grouping of several EPWMs.

FIG. 3 illustrates the logical mapping between Manufacturing Context, EPWMs, Equipment Type and Equipment Instance.

FIG. 4 shows a schematic of an embodiment of the present invention.

FIG. 5 illustrates the logical mapping to configure Notification Activation.

### DETAILED DESCRIPTION OF INVENTION

The present invention provides a Method and System for Adaptive Equipment Notifications for automated manufacturing equipment. The main benefit of the invention is generating actionable notifications in the production environment based on detected equipment conditions and user-definable manufacturing contexts.

An Equipment Notification has the following 3 characteristics:
1. A Main-Category, for example “Equipment Processing Out-of-Spec”, “Equipment Failure”, of “Equipment Preventive Maintenance Recommendation”.
2. A Sub-Category
3. A Detailed Notification Context, for example date/time of occurrence, system state, or time-related window of equipment history.

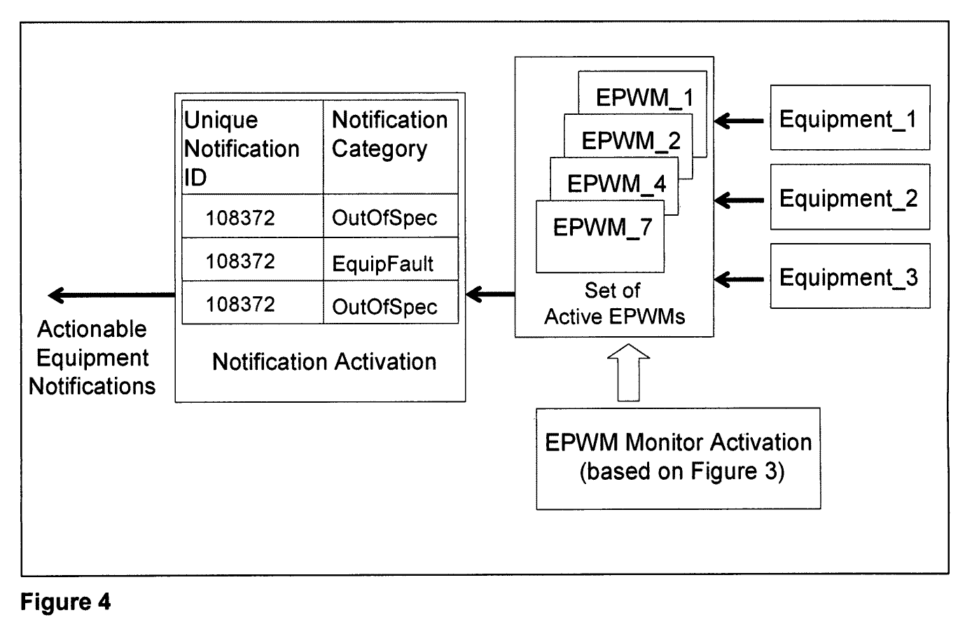

FIG. 4 shows one embodiment of the present invention. A set of automated manufacturing equipment provides equipment data that is evaluated by a set of Equipment Process Window Modules (EPWM). The active set of EPWMs is selected by an EPWM Monitor Activation entity. Notifications generated by the set of EPWMs are received by a Notifications Activation entity for further processing, configuration and dispositioning to the Equipment Notification consumer.

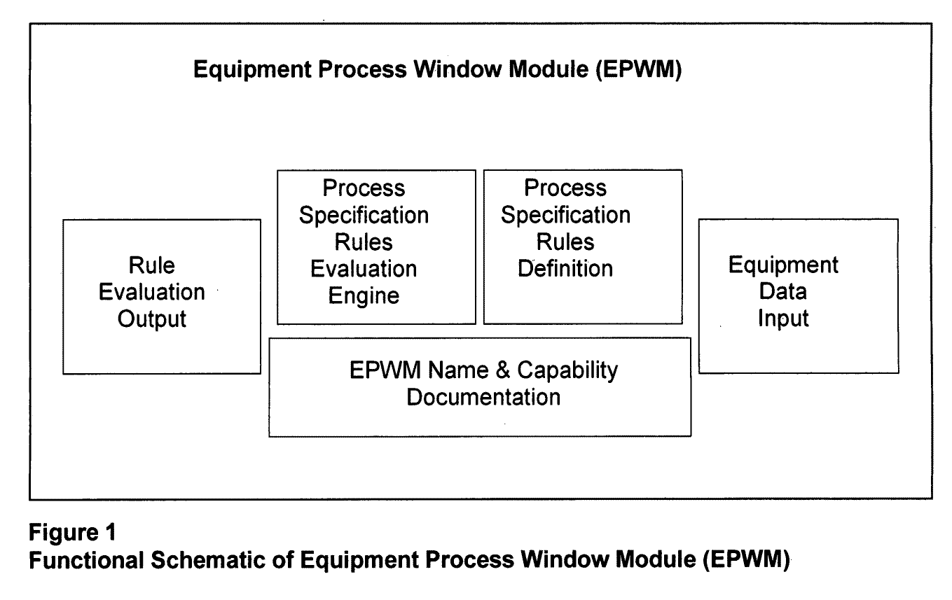

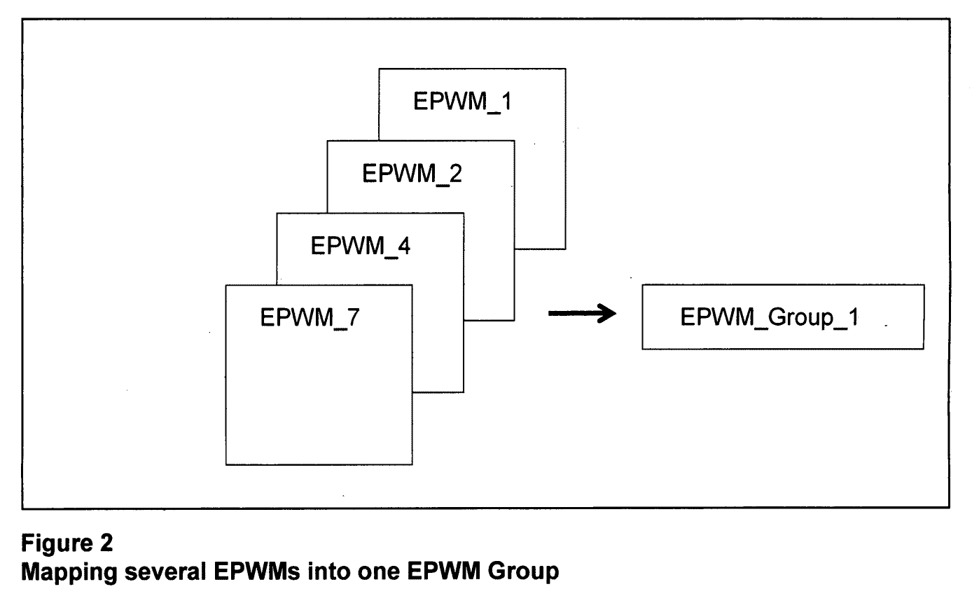

An EPWM contains the rules and evaluation engine to determine whether a particular equipment is performing within a desired operating range. FIG. 1 shows a functional schematic of an EPWM. An EPWM also specifies which Equipment Notification (including Main-Category, Sub-Category, Detailed Notification Context) shall be generated if the equipment is found to be outside of the specified operating range. Each EPWM shall be identifiable by a unique name, and may include documentation describing its capability and typical process application, where applicable. Several EPWMs may be grouped under one EPWM Group Name as shown in FIG. 2. Embodiments of EPWMs are COM+ components or Web Services in a Service Oriented Architecture, however the full range of possible embodiments is not limited to those two.

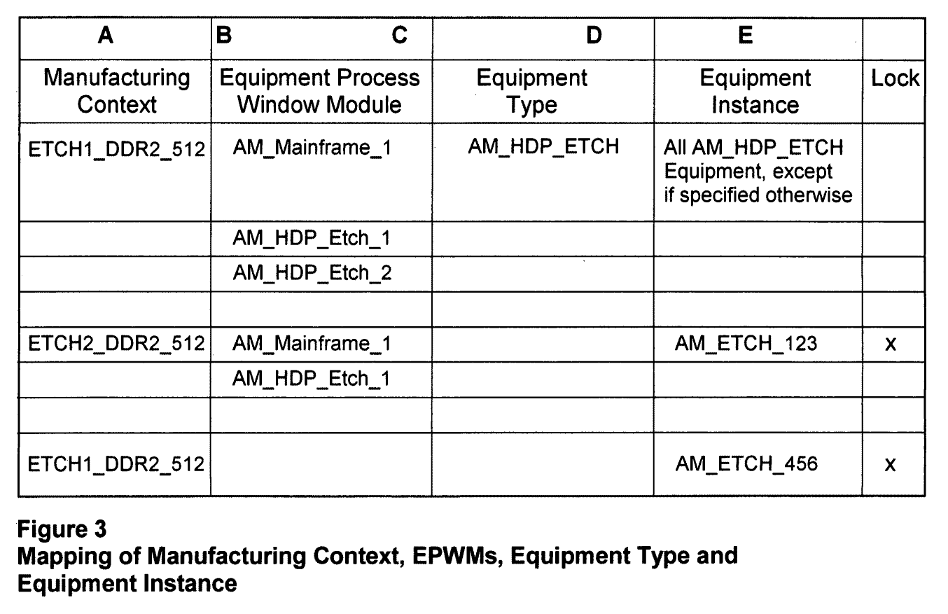

FIG. 3 shows an important component of the present invention, describing how EPWMs are being applied to automated Equipment Types or Equipment Instances in order to support different customer Manufacturing Contexts. FIG. 3 describes the logical mapping contained within the EPWM Monitor Activation, shown in the overall system schematic (FIG. 4). A Manufacturing Context is a specific usage of an Equipment Instance or Equipment Type, typically related to the manufacturing of a particular product. Within the present invention, each Manufacturing Context is identifiable by a unique name. The definition of the correlation between EPWM and Manufacturing Context is supported both for an Equipment Type and for a particular Equipment Instance. An Equipment Type is a group of similar production equipment, typically from the same vendor, e.g. “Vendor A Etch Systems”. A particular Equipment Instance is a singular piece of processing equipment, typically characterized by its location within the factory. The present invention specifies the capability to override a previously mapped EPWM selection for an Equipment Type with a different selection for a particular Equipment Instance. The present invention further specifies that an EPWM selection for an Equipment Instance can be locked to prevent override from a subsequent EPWM selection at the Equipment Type level.

The present invention specifies that mapping a Manufacturing Context name either to an Equipment Type or to an Equipment Instance activates the monitoring. The configured EPWM for that Manufacturing Context is being utilized for monitoring. The mapping operation is supported both through a programming interface by providing the Manufacturing Context name and Equipment Type or Equipment Instance, and through a Process Window Configuration User Interface, which in its appearance is similar to FIG. 3. It is possible to define a Manufacturing Context name without any corresponding EPWM, thereby effectively disabling process window monitoring when that Manufacturing Context is activated for an equipment.

Column E in FIG. 3, called “Lock”, indicates whether a particular Equipment Instance is locked to an EPWM configuration for a given Manufacturing Context, no matter whether an EPWM selection has been made for the corresponding Equipment Type that this Equipment Instance belongs to. Example 3 starting on row 8 in the table in FIG. 3 shows such a case, overriding the previous configuration from Example 1's entries in rows 2-4. Example 3 also illustrates a configuration where no EPWM monitoring is being performed for Equipment Instance “AM_ETCH_{—}123” for Manufacturing Context “ETCH1_DDR2_{—}512”.

Example 2 in FIG. 3, contained in rows 6-7, illustrates a case where only a single Equipment Instance is being configured with EPWM monitoring. All other instances within that same Equipment Type will not be monitored for Manufacturing Context “ETCH2_DDR2_{—}512”.

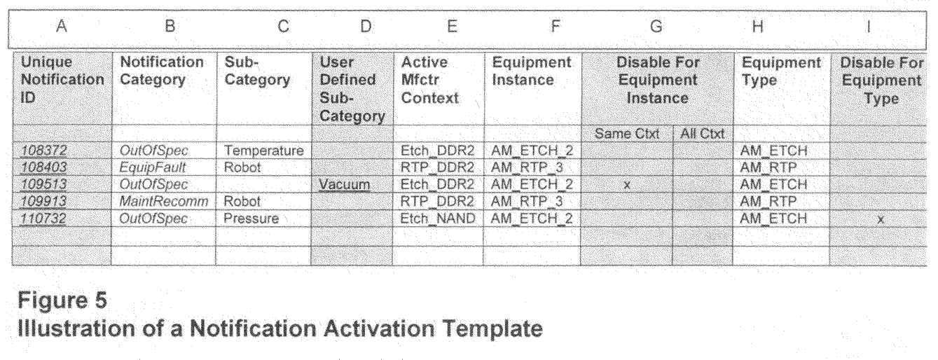

Another important characteristic of the present invention is the ability to turn off any combination of Notification Categories and Sub-Categories, e.g. for the duration of an equipment maintenance operation. A Sub-Category is identifiable and selectable by the notification consumer only after it had been received for the first time. The corresponding ability to enable Notification Categories and Sub-Categories is provided. Enabling and disabling of Notifications is supported both by Equipment Type and Equipment Instance, and is supported both manually through a configuration user interface similar in appearance to FIG. 5 and through a programming interface providing the Category, Sub-Categories, Manufacturing Context(s) and Equipment Types or Equipment Instances.

Another important part of the present invention is the capability to initially assign and later modify a unique text label and a text comment for any previously received Notification Sub-Category. The unique label and the comment are for future reference, and are modifiable regardless of whether the particular Sub-Category is enabled or disabled.

FIG. 5 shows the Notification Activation method and a user interface embodiment. The rows in the table show Equipment Notifications with their available information that were generated by the EPWM set. The shaded columns A, D, G, and I are open for user interaction. Column A shows a unique notification ID that gets generated by the system for each notification received from EPWMs. Clicking on the ID hyperlink will provide any available Detailed Notification Context. Column D shows the capability to input a user-defined, unique Sub-Category name. Clicking on the hyperlink of a verified unique name allows for review and/or input of Sub-Category documentation information. Columns G and I show the capability to disable or enable that particular notification for the Equipment Instance for either the same Manufacturing Context or all Manufacturing Contexts.

The processing of EPWM generated Equipment Notifications by the Notification Activation entity (see FIG. 4) generates actionable Equipment Notifications that are then sent to the notification consumer via a communications network. The consumer, in most cases the manufacturer, has the ability through the present invention to adapt the Equipment Notifications to the evolving needs of their manufacturing operations.

1. A method for generating Adaptive Equipment Notifications, based on equipment data from automated manufacturing equipment, comprising:
the configuration of Equipment Process Window Modules (EPWM)
the configurable activation of EPWM monitoring
the configurable activation of Equipment Notifications for sending to a notification consumer via a communications network

2. The method of claim 1 wherein the activation of EPWM Monitoring is configurable based on Manufacturing Context.

3. The method of claim 2 wherein the EPWM Monitoring for a particular Manufacturing Context can be activated for either an Equipment Type or an Equipment Instance.

4. The method of claim 3 wherein the mapping between Manufacturing Context, EPWM or EPWM Group and a particular Equipment Instance can be locked from override by another mapping for the corresponding Equipment Type.

5. The method of claim 1 wherein Equipment Notifications can be disabled and enabled based on Manufacturing Context, Equipment Type and Equipment Instance.

6. The method of claim 1 wherein the notification consumer can assign a unique Sub-Category name and corresponding documentation to a received Equipment Notification.

7. A system for generating Adaptive Equipment Notifications comprising:
an EPWM Monitor Activation component selecting active EPWMs for a given Manufacturing Context and a given set of automated equipment
a Notification Activation component receiving Equipment Notifications from EPWMs, providing for configurable dispositioning of Equipment Notifications to the notification consumer via a communications network.

8. The user interface component of claim 7 wherein the mapping between Manufacturing Context, EPWM(s) or EPWM Group(s), Equipment Type and Equipment Instance can be configured.

9. The user interface function of claims 4 and 8 that provides for locking of the mapping between Manufacturing Context, EPWM or EPWM Group and a particular Equipment Instance.

10. The programming interface of claims 2, 3, and 8, whereby the mapping between Manufacturing Context, EPWM or EPWM Group, Equipment Type and Equipment Instance can be configured.

11. The user interface component of claims 5 and 7, wherein Equipment Notifications can be disabled and enabled based on Manufacturing Context, Equipment Type and Equipment Instance.

12. The user interface component of claims 6 and 7, wherein the notification consumer can assign a unique Sub-Category name and corresponding documentation to a received Equipment Notification.

13. The user interface component of claim 7 wherein received Equipment Notifications, their Manufacturing Context, the corresponding Equipment Instance and corresponding configurations can be exported into a file.
